(19) United States
(12) Patent Application Publication
(10) Pub. No.: US 2018/0340075 A1
(43) Pub. Date: Nov. 29, 2018

(54) NANO-COMPOSITE ANTI-FINGERPRINT COATING

(71) Applicant: Henkel AG & Co. KGaA, Duesseldorf (DE)

(72) Inventors: Umesh D. Harkal, Nashik (IN); John Zimmerman, Taylor, MI (US); John D. McGee, Troy, MI (US); Gregory T. Donaldson, Sterling Heights, MI (US); Libin Du, Troy, MI (US)

(21) Appl. No.: 16/019,664

(22) Filed: Jun. 27, 2018

Related U.S. Application Data
(63) Continuation of application No. PCT/US2016/067438, filed on Dec. 19, 2016.
(60) Provisional application No. 62/271,489, filed on Dec. 28, 2015.

(51) Int. Cl. C09D 5/00; C09D 7/40; C09D 171/00; C09D 175/16; B05D 1/02; B05D 3/02

(52) U.S. Cl. CPC C09D 5/00; C09D 7/67; B05D 3/0272; C09D 175/16; B05D 1/02; C09D 171/00

(57) ABSTRACT

A polymeric coating composition comprising a polymeric binder composition, a plurality of nanoparticles, a solvent and a polymeric evaporative droplet templating agent that is different from the polymeric binder is provided. The coating composition can be spray applied to a wide variety of substrates and the as-applied coating composition is then dried and cured into a coating that exhibits a droplet-shaped morphology. The coating provides a highly effective anti-fingerprinting coating with a unique droplet-shaped morphology that can be seen using scanning electron microscopy and provides a cost-effective means to coat substrates having many different surface contours to hide fingerprints.

### FIELD OF THE INVENTION

This invention relates generally to coatings for a variety of substrates and more particularly to a coating that prevents fingerprints from being visible on the substrate, and compositions and methods for depositing such coatings.

### BACKGROUND OF THE INVENTION

An ongoing problem in multiple industries is developing methods and coatings that serve to address the adverse effects of visible fingerprints on surfaces of consumer goods. These approaches vary from making the surfaces easier to clean, making transfer more difficult and methods to hide fingerprints on a variety of surfaces. Prior art attempts have had limited success. The prior art methods for creating textured surfaces in an attempt to hide fingerprints are expensive and involve complex processes such as plasma deposition and chemical vapor deposition. There are many approaches taken in the prior art to provide textured surfaces which are utilized to provide benefits toward fingerprinting, particularly the ease of cleaning or other optical properties.

US Publication No. 2010/0304086 describes a specialized coating surface texture created by at least three sequential steps of: grinding the substrate; chemically generating a silica over the roughened surface via pyrolysis of an alkyltrichorosilane; and then overcoating with a perfluoroalkyl-based coating material to make the surface hydrophobic which is described as reducing fingerprint deposition and facilitating easy fingerprint removal via wiping. However, this approach involves mechanical and chemical steps which are time consuming and expensive rendering it unsuitable for mass production.

US Publication No. 2013/0323466 A1 discloses gas-trapping features in a coating to provide an oleophobic surface that resists fingerprinting. Gas trapping features are provided by application of a patterned maskant coating which can be overcoated with a permanent coating composition. Subsequent processing steps remove the masking material, such as dissolution or etching, to provide the gas trapping features. Similarly, WO201288209A2 discloses omni-phobic articles which possess micro and nano-scale surface features such as can be provided by engineering an array of pillars, wires, rods, and/or cone structures. Publication EP 1555249A1 discloses hydrophobic and/or oleophobic coating compositions that when applied to micro-structured glass surfaces provide an “anti-fingerprint” effect. The number of steps required and the cost of these solutions makes them unsuitable for mass production.

US Publication No. 2010/0033818 A1 discloses mechanically applying a surface pattern of discreet curved elongated micro-structures with defined dimensions geometry and spacing by stamping, embossing, or formation with a mold. However this approach does not lend itself to use on 3-dimensional non-flat substrates. Similarly, U.S. Pat. No. 8,246,896-B2 describes UV-curable compositions which require a mold; when applied and cured within the mold the mold creates specific surface structures in the coating. U.S. Pat. No. 8,771,532-B2 discloses a glass article with an antiglare surface provided via specific texture and roughness achieved through various etching processes. Certain embodiments include a subsequently applied fluorine-based coating layer that is described as providing resistance to smudging by finger touches. In US Publication No. 2009/0022948 A1 disclosed are anti-glare layers wherein the layer constitutes a polymer matrix further containing phase-separated polymeric domains stemming from inherent incompatibility of the polymers in the coating. US Publication No. 2012/0171421 A1 discloses an anti-fingerprint coating for metal or glass which constitutes two sequentially applied layers of non-crystalline alumina and non-crystalline aluminum-oxygen-fluorine. The coating layers are applied by magnetron sputtering method and result in a nano-scale surface texture. PCT Publication WO2006131540 A1 discloses a method to treat glossy surfaces such that the resulting glossy surface hides dirt which includes fingerprints. The process involves applying a series of coating layers, as many as 4, the first having a thickness of from 10 to 300 nanometers, and subsequent layers having thicknesses of less than 100 nanometers such that colored inference patterns are produced with defined lateral dimensions which are a basis for hiding soils and fingerprints. In forming the subsequent layer(s), plasma is used to deposit and crosslink a gaseous coating precursor.

None of these prior art solutions have been found satisfactory in the coating industry. Thus there has been a need to provide a coating composition which is useful for depositing a coating that is effective at hiding fingerprints that does not require expensive and time-consuming procedures to apply to surfaces. Desirably, the coating composition can be applied to a wide variety of substrates and surface contours. In addition, it is preferable that the coating on substrate surfaces provides improved hardness and anti-glare properties to the coated surfaces.

### SUMMARY OF THE INVENTION

In general terms, this invention provides a coating composition comprising components that interact in fine droplet particles of the composition thereby reducing coalescence of the droplet particles after they contact a substrate surface such that the droplet particles substantially retain a droplet shape and morphology. In contrast to some known anti-fingerprint coating compositions, Applicants' composition is cost effective to prepare and to apply to a wide range of substrates. The coating effectively hides fingerprints on substrate surfaces when applied according to the present invention in part due to a unique morphology of the coating once dried and cured on the surface. The morphology may make fingerprints difficult to detect based on light scattering by the droplet shaped morphology of the solid particles of the coating. The coating also provides hardness, scratch resistance and abrasion resistance to the coated substrate. In addition, the cured coating provides a unique haptic quality to coated metal surfaces, such that a coated metal surface feels uncoated to a human hand; that is the coated metal surface still feels like a metallic rather than a polymeric surface. This is a benefit in certain consumer goods, for example in the hand-held electronics market where consumers expect certain surfaces to be made of metal and to feel like metal, but at the same time they do not want visible fingerprints on the surfaces.

In one embodiment, the present invention is a liquid coating composition comprising: A) a film forming polymeric binder composition; B) a plurality of nanoparticles; C) a polymeric templating agent that is different from the polymeric binder A); and D) a solvent. Another embodiment is a method of using liquid coating compositions disclosed herein as a spray applied coating composition that has a droplet-shaped morphology as deposited on a substrate which morphology is retained in the coating, i.e. a cured coating.

In another embodiment, the present invention is an article of manufacture comprising a substrate surface and deposited thereon a coating comprising a film forming polymeric binder composition, a plurality of nanoparticles, and a polymeric templating agent that is different from the polymeric binder composition; and wherein the coating has a droplet-shaped morphology when cured on the substrate.

In another embodiment the present invention is a method of forming a coating on a substrate comprising the steps of: a) providing a liquid coating composition comprising a film forming polymeric binder composition, a plurality of nanoparticles, a polymeric templating agent that is different than the polymeric binder composition, and a solvent; b) spray applying the coating composition to a substrate in droplet form creating an uncured coating having a droplet-shaped morphology, which is retained in the uncured coating, in an amount to provide a dried cured coating thickness of 2 microns or greater; and c) curing the coating composition on the substrate thereby forming a coating having a droplet-shaped morphology on the substrate.

In another embodiment, the present invention is an article of manufacture comprising a substrate surface and adhered thereon a polymeric coating comprising droplet-shaped cured polymer, and a plurality of nanoparticles dispersed in the droplet-shaped cured polymer.

These and other features and advantages of this invention will become more apparent to those skilled in the art from the detailed description of a preferred embodiment. The drawings that accompany the detailed description are described below.

Other than in the operating examples, or where otherwise indicated, all numbers expressing quantities of ingredients, reaction conditions, or defining ingredient parameters used herein are to be understood as modified in all instances by the term “about”. Throughout the description, unless expressly stated to the contrary: percent, “parts of”, and ratio values are by weight or mass; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description or of generation in situ within the composition by chemical reaction(s) between one or more newly added constituents and one or more constituents already present in the composition when the other constituents are added; specification of constituents in ionic form additionally implies the presence of sufficient counterions to produce electrical neutrality for the composition as a whole and for any substance added to the composition; any counterions thus implicitly specified preferably are selected from among other constituents explicitly specified in ionic form, to the extent possible; otherwise, such counterions may be freely selected, except for avoiding counterions that act adversely to an object of the invention; molecular weight (MW) is weight average molecular weight; the number average molecular weight is (Mn); the word “mole” means “gram mole”, and the word itself and all of its grammatical variations may be used for any chemical species defined by all of the types and numbers of atoms present in it, irrespective of whether the species is ionic, neutral, unstable, hypothetical or in fact a stable neutral substance with well-defined molecules.

For a variety of reasons, it is preferred that coating compositions according to the invention may be free or substantially free from many ingredients used in compositions for similar purposes in the prior art. Specifically, it is increasingly preferred in the order given, independently for each preferably minimized ingredient listed below, that compositions according to the invention, contain no more than 1000, 500, 350, 100, 80, 40, 20, 10, 1, or 0.2 parts per million of each of the following constituents: fluorinated hydrocarbons, water insoluble solid particles having an average diameter of 20 microns or greater and evaporative solvents or solvent mixtures that do not match the evaporation rate profile for suitable solvents described herein.

### BRIEF DESCRIPTION OF THE DRAWINGS

FIG. 1A (magnification 100×), FIG. 1B (magnification 250×) and FIG. 1C (magnification 500×) show scanning electron microscopy (SEM) images of comparative coating Comp. Ex. 1 not according to the present invention applied on a Bonderite 5200 treated aluminum substrate;

FIG. 2A (magnification 100×), FIG. 2B (magnification 250×) and FIG. 2C (magnification 500×) show SEM images of Coating Inv. 3A applied according to the present invention on a Bonderite 5200 treated aluminum substrate;

FIG. 3A (magnification 250×) and FIG. 3B (magnification 500×) show SEM images of the same coating as FIGS. 2A-2C wherein the SEM process was changed to better show the three-dimensional aspects of the coating droplet-shaped morphology;

FIG. 4 shows a graph of the percent transmission haze versus applied coating thickness for Coating Inv. 3C according to the present invention applied to a glass substrate;

FIG. 5A (magnification 250×) and FIG. 5B (magnification 500×) show SEM images of Coating Inv. 3A according to the present invention applied to an anodized aluminum substrate by a drawbar application as a comparative example rather than a spraying application;

FIG. 6A (magnification 500×) and FIG. 6B (magnification 1000×) show SEM images of Coating Inv.5E applied according to the present invention on Bonderite 5200 treated aluminum substrate;

FIG. 7A (magnification 500×) and FIG. 7B (magnification 1000×) show SEM images of Coating Inv. 5A applied according to the present invention on Bonderite 5200 treated aluminum substrate;

FIG. 8A (magnification 500×) and FIG. 8B (magnification 1000×) show SEM images of Coating Inv. 5B applied according to the present invention on Bonderite 5200 treated aluminum substrate;

FIG. 9A (magnification 500×) and FIG. 9B (magnification 1000×) show SEM images of Coating Inv. 5C applied according to the present invention on Bonderite 5200 treated aluminum substrate; and

FIG. 10A (magnification 500×) and FIG. 10B (magnification 1000×) show SEM images of Coating Inv. 5 D applied according to the present invention on Bonderite 5200 treated aluminum substrate at magnifications.

### DETAILED DESCRIPTION OF THE INVENTION

Throughout the present specification and claims the term “coating composition” refers to the coating formulation prior to application to a substrate, typically the coating composition may be a liquid. The term “coating” refers to the dried and cured coating on a substrate. The term “droplet-shaped morphology” is used to describe the morphology of the coatings created by the method of the present invention using the coating compositions of the present invention on a substrate. This droplet-shaped morphology is visible and readily identifiable by the unique shapes seen at a magnification of as low as 100× when a coated substrate is view using scanning electron microscopy as described herein. The droplets do not coalesce once on the substrate surface in any significant amount; even with small amounts of coalescence, the droplet-shaped morphology is retained. This droplet-shaped morphology is visible in the uncured coating composition after spray application to a substrate surface and is retained when the applied coating composition is cured on the substrate surface to form the coating.

The present invention is directed toward sprayable coating compositions for application to substrates wherein the dried and cured coating has a unique droplet-shaped morphology and surface texture. The droplet-shaped morphology of the coating allows it to be used in a wide variety of end uses ranging including in anti-fingerprint coatings, anti-glare coatings, and anti-scratch coatings. The droplet-shaped morphology and surface texture in the coatings is provided by evaporative droplet templating. The coating composition comprises A) a film forming polymeric binder, B) nanoparticles, C) a polymeric templating agent that is different from the polymeric binder and D) a solvent. It is applied by a process of creating fine atomized droplets of the coating composition and projecting them onto a substrate, designated herein as spray application. Preferably the process used to form the atomized droplets comprises a forced air or airless atomization spray. While the formed droplets travel to the substrate the droplets lose solvent due to evaporation. While not wishing to be bound by theory, with the loss of solvent from a droplet the strong interaction of nanoparticles, templating agent, and polymeric binder are triggered such that the integrity of the droplet is maintained after deposition on the substrate prior to curing and after curing. Thus, the deposited coating has a droplet-shaped morphology and surface texture. The droplets do not coalesce once on the substrate surface, meaning the droplets do not combine to form a single mass. Desirably, the droplets form a contiguous coating over the substrate surface without losing their droplet shape and without forming an evenly distributed uniform layer on the substrate surface. The droplet-shaped morphology is retained when the coatings are dried and cured on the substrate. Despite the maintenance of the non-coalesced droplets on the substrate after curing the coating retains the same hardness and abrasion resistance as is found in a fully coalesced evenly distributed uniform coating. This result is unexpected as one would expect that a non-coalesced coating would not be hard or abrasion resistant. In one embodiment the coating serves as an anti-fingerprint coating. The dried and cured coating, because of its droplet-shaped morphology and texture, as more fully explained herein, has very low gloss and peak specular reflectance which serves to limit the fingerprint visibility. Another attribute of the coating is that its surface texture provides a unique haptic quality to the coated substrate. In one embodiment the coating composition is applied to a metal substrate, meaning a substrate having surfaces made of metal, preferably stainless steel, aluminum, magnesium, titanium and alloys thereof, and the coated metal substrate retains the feel of metal even with a coating that is 10 microns thick. The unique droplet-shaped morphology provided by the coating is maintained as the coating thickness is increased meaning the coating morphology is not thickness dependent. It must be applied to a substrate via a sprayed method involving fine droplets to cause formation of the unique droplet-shaped morphology, surface texture and anti-fingerprint effect. If the coating composition is applied by another method which does not involve the formation of fine droplets which are projected onto the substrate, for example methods such as a drawbar application, roll application, dip application, or curtain application it does not form the same structural droplet-shaped morphology and it does not have the fingerprint hiding abilities and is more prone to fingerprinting.

The coating composition can be applied to a variety of substrates including: a metal; a plastic surface, both transparent and non-transparent; a glass; a peelable backing material; a film; a ceramic material, which can be a metal oxide-based coating, e.g. a coating comprising oxides of Al, Mg, Zr, Ti and mixtures thereof, on a substrate; a composite material, and combinations thereof. The coating composition may be spray applied directly to a substrate or may be applied to a peelable backing material to form a film or sheet with the backing material which can then be pressed onto a substrate. Direct application of the coating composition to a substrate is preferred.

One significant advantage of the present coating composition and methods of applying same is that the substrate to be coated requires no pre-treatment in order to achieve the coating exhibiting the droplet-shaped morphology. As discussed in the background of the specification, many of the prior art approaches require pre-texturizing or roughening of the substrate surface prior to application of their coatings to achieve their effects. The present invention avoids any need for these pre-treatment or roughening effects. Thus, even if applied to smooth substrates, the present invention is able to create the textured droplet-shaped morphology because it is a function of the coating composition and method of application and not of the surface to which it is applied. In some embodiments of the invention, the method of generating the coating is in the absence of etching, honing, embossing, patterning, texturizing or otherwise roughening the substrate surface prior to deposition of the coating. Desirably, the method of generating the coating with the droplet-shaped morphology is in the absence of generating the droplet-shaped morphology using a mold or the like to shape the coating composition and/or by stamping, embossing or otherwise physically modifying the coating after deposition of the droplets.

In addition, since the coating composition is applied via a droplet formation, e.g. spray application; the coating composition can be applied to a substrate having any surface contour. The invention will find use in a variety of industries, e.g. personal handheld electronics, and in a wide range of consumer goods such as appliances and automotive surfaces, wherein there is a desire to hide fingerprints. It also finds use as an application to enclosures for use in electronics, computer cases, computer components, and digital display devices. In a digital display application, the coating provides anti-fingerprint properties along with anti-glare and anti-scratch properties.

A coating composition according to the present disclosure may comprise the following components: a curable polymeric binder composition, which is preferably an ultraviolet curable polymer, but can also be one or more of a thermosetting polymer or polymeric binder precursors; a plurality of nanoparticles; a solvent system; an evaporative droplet templating agent that is different from the polymeric binder; and optionally, coating additives such as adhesion promoting agents, slip agents, cosmetic additives including dyes, when the polymeric binder is UV curable then a photoinitiator is also included in the composition, for curing thermosetting polymeric binders UV stabilization additives may be used in the composition.

The coating composition can be prepared simply by mixing the components together with stirring. The order of mixing may start with the polymeric binder composition; adding nanoparticles, if not already present in one of the binder components; followed by addition of photoinitiator (if being used); the solvent and the templating agent.

After spray application of the coating composition and before curing, heated drying can be used to remove solvent residues from the coating; desirably the cured coating has no or very little residual solvent present. The term “evaporative droplet templating agent” is a term the present inventors have coined for the component, described herein, that aids in forming droplets that do not coalesce after application to a substrate by a droplet method. This is what leads to a coating having a droplet-shaped morphology as shown herein. The term is further defined herein, and in the present specification and claims, the terms “evaporative droplet templating agent” and “templating agent” mean the same thing as described herein.

The polymeric binder composition A) according to the present invention is a film forming composition comprising one or more polymers and/or prepolymers, desirably organic polymers and/or prepolymers, which are crosslinkable. In a preferred embodiment the film forming polymeric binder composition comprises one or more UV curable polymers or UV curable polymer precursors. In another embodiment the film forming polymeric binder can comprise thermosetting polymers and prepolymers which are made crosslinkable by addition of known crosslinking agents. In some embodiments the film forming polymers can comprise any combination selected from UV curable polymers, UV curable polymer precursors, thermosetting polymers and thermosetting prepolymers. The film forming polymeric binder composition may be present in an amount of from about 40 to 95 weight percent, more preferably from 45 to 85 weight percent based on the total dried coating weight, in increasing order of preference the amount is at least 40, 41, 42, 43, 44, 45, 46, 47, 48, 49, 50, 51, 52, 53, 54, 55, 56, 57, 58, 59, 60, 61, 62, 63, 64, 65, 66, or 67 weight percent and not more than 95, 94, 93, 92, 91, 90, 89, 88, 87, 86, 85, 84, 83, 82, 81, 80, 79, 78, 77, 76, 75, 74, 73, 72, 71, 70, 69, 68, or 67.

Suitable polymeric binders include a wide range of film forming polymers, including but not limited to: (meth)acrylic polymers; polyurethane polymers; polyester polymers; and vinyl polymers, such as polyvinyl butyral resins (PVB). The term (meth)acrylic polymer is meant to describe homopolymers and/or copolymers comprising mixtures of acrylic acid, acrylic acid esters, methacrylic acid, methacrylic acid esters, styrene and mixtures thereof. The term polyurethane polymer means a polymer that contains urethane groups in the polymer. The term polyester polymer means a polymer that contains ester groups in the polymer. The term vinyl polymer means a polymer derived from vinyl group containing monomers. As described herein in the specification and claims and as known in the art the term monomer does not mean only a single repeating unit, it can include prepolymer or oligomer backbones terminated with reactive function groups such as acrylic acid and methacrylic acid groups. Examples of all of these monomers are provided herein below and are well understood by those of skill in the art. When the preferred UV curable film forming polymeric binders are used this means the polymer includes pendant and/or terminal acryloyl or methacryloyl groups, which can be prepared as is known in the art by reaction of functionalized prepolymers with acrylic and/or methacrylic acid. These pendant and/or terminal acryloyl or methacryloyl groups provide the UV curable function to the film forming polymeric binder composition. The backbone structure between these pendant and/or terminal acryloyl or methacryloyl groups can vary widely as described herein for the non-UV curable film forming polymeric binders. In certain embodiments, thermosetting polymeric binders, meaning those that are not UV curable because they do not include pendant and/or terminal acryloyl or methacryloyl groups, suitable for the present invention can be achieved through inclusion of auxiliary crosslinking agents such as blocked isocyanates as is known in the art.

In a preferred embodiment, the coating composition is UV-curable and the polymeric binder composition comprises UV curable film forming polymers formed from mixtures of monomers and/or polymer precursors bearing ethylenic unsaturation. Binder polymer precursors, for both UV curable and thermosetting polymers, may possess 1 or more ethylenically unsaturated groups. Examples of suitable acrylate and methacrylate monomers having a polymerizable double bond that can be used to form both UV curable and thermosetting polymeric binders include but are not limited to: alkyl acrylates; alkyl methacrylates; hydroxyalkyl acrylates; hydroxyalkyl methacrylates; substituted alkyl acrylates or alkyl methacrylates like 2 ethylhexyl acrylate or 2 ethylhexyl methacrylate; and other acrylates and methacrylates such as isobornyl acrylate; and mixtures thereof.

Other suitable examples of acrylate and methacrylate monomers having more than one double bond include, but are not limited to polyacrylate and polymethacrylate functional monomers such as: ethylene glycol diacrylate; propylene glycol diacrylate; diethylene glycol diacrylate; dipropylene glycol diacrylate; triethylene glycol diacrylate; tripropylene glycol diacrylate; tertraethylene glycol diacrylate; tetrapropylene glycol diacrylate; polyethylene glycol diacrylate; polypropylene glycol diacrylate; ethoxylated bisphenol A diacrylate; bisphenol A diglycidyl ether diacrylate; resorcinol diglycidyl ether diacrylate; 1,3-propanediol diacrylate; 1,4-butanediol diacrylate; 1,5-pentanediol diacrylate; 1,6-hexanediol diacrylate; neopentyl glycol diacrylate; cyclohexane dimethanol diacrylate; ethoxylated neopentyl glycol diacrylate; propoxylated neopentyl glycol diacrylate; ethoxylated cyclohexanedimethanol diacrylate; propoxylated cyclohexanedimethanol diacrylate; epoxy polyacrylates; aryl urethane polyacrylates; aliphatic urethane polyacrylates; polyester polyacrylates; trimethylol propane tri (meth)acrylate; glycerol tri (meth)acrylate; ethoxylated trimethylolpropane tri(meth)acrylate; propoxylated trimethylolpropane tri(meth)acrylate; trimethylolethane tri(meth)acrylate; tris (2-hydroxyethyl) isocyanurate triacrylate; ethoxylated glycerol tri(meth)acrylate; propoxylated glycerol tri(meth)acrylate; pentaerythritol tri(meth)acrylate; melamine triacrylates; epoxy novolac triacrylates; aliphatic epoxy triacrylates; and mixtures thereof. Preferred tetraacrylates that are also suitable alone or in combination with the above monomers include, but are not limited to: di-trimethylolpropane tetra(meth)acrylate; pentaerythritol tetra(meth)acrylate; ethoxylated pentaerythritol tetra(meth)acrylate; propoxylated pentaerythritol tetra(meth)acrylate; dipentaerythritol tetra(meth)acrylate; ethoxylated dipentaerythritol tetra(meth)acrylate; propoxylated dipentaerythritol tetra(meth)acrylate; divinylbenzene; divinyl succinate, diallyl phthalate; triallyl phosphate; triallyl isocyanurate; tris(2-acryloyl ethyl)isocyanurate; aryl urethane tetra(meth)acrylates; aliphatic urethane tetra(meth)acrylates; polyester tetra(meth)acrylates; melamine tetra(meth)acrylates; epoxy novolac tetra(meth)acrylates; and mixtures thereof. Higher functional acrylates that are also suitable include, but are not limited to: dipentaerythritol penta(meth)acrylate; dipentaerythritol hexa(meth)acrylate; tripentaerythritol octa(meth)acrylate; and mixtures thereof. These monomers can be used to form both the UV curable polymeric binder and the thermosetting polymeric binder.

The nanoparticles B) used in the present invention can comprise nanoparticles of the metal oxides silica (SiO₂), titania, alumina, zirconia, cerium and combinations thereof. Preferably the nanoparticles have an average diameter of from 5 to 120 nanometers (nm), preferably the average diameter is at least 5, 6, 7, 8, 9, 10, 11, 12, 13, 14, 15, 16, 17, 18, 19, 20, 25, 30, 35, 40, 45, 50, 55, or 60 nm and not more than 120, 119, 118, 117, 116, 115, 114, 113, 112, 111, 110, 109, 108, 107, 106, 105, 104, 103, 102, 101, 100, 95, 90, 85, 80, 75, 70, or 65, or 60. More preferably the average diameter is from 10 to 100 nm, preferably at least 10, 11, 12, 13, 14, 15, 16, 17, 18, 19, 20, 25, 30, 35, 40, 45, or 50 and not more than 100, 99, 98, 97, 96, 95, 94, 93, 92, 91, 90, 85, 80, 75, 70, 65, 60, 55, or 50 nm. Most preferably the average diameter is from 15 to 50 nm, preferably at least 15, 16, 17, 18, 19, 20, 21, 22, 23, 24, 25, 26, 27, 28, 29, 30, or 35 and not more than 50, 49, 48, 47, 46, 45, 44, 43, 42, 41, 40, or 35. The silica nanoparticles can include those known as fumed silica made in a flame or silica sol made in a lower temperature sol gel process. The nanoparticles may be incorporated into the coating composition as solids; however dispersions or colloidal suspensions of the nanoparticles in a carrier may also be used. Preferred carriers include water or solvents such as alcohols, ketones, glycol ethers and aromatic solvents, carriers for nanoparticle sol gel formed nanoparticles include additives for pH adjustment or size distribution. The polymeric binder can also serve as a carrier for the nanoparticles. In one embodiment, the nanoparticles may be a colloidal suspension in the polymeric binder composition. The nanoparticles can include surface modifications to increase their compatibility with and dispersibility in the carrier and/or polymeric binder composition. The nanoparticles can be surface modified with surfactants, silane coupling agents, epoxy compounds, hydroxyl compounds, acid compounds, ether compounds, and isocyanate compounds to improve their colloidal stability in the polymeric binder composition, to allow crosslinking with the binder, or to affect the level of interaction with the templating agent. The nanoparticles may comprise from 5 to 60 weight percent of the dried coating, preferably at least 5, 6, 7, 8, 9, 10, 11, 12, 13, 14, 15, 16, 17, 18, 19, 20, 25, 30, or 35 and not more than 60, 59, 58, 57, 56, 55, 54, 53, 52, 51, 50, 49, 48, 47, 46, 45, 44, 43, 42, 41, 40, or 35, More preferably 15 to 55 weight percent, preferably 15, 16, 18, 19, 20, 21, 22, 23, 24, 25, 26, 27, 28, 29, 30, 31, 32, 33, 34, or 35 and not more than 55, 54, 53, 52, 51, 50, 49, 48, 47, 46, 45, 44, 43, 42, 41, 40, 39, 38, 37, 36, or 35.

The solvent component D) used according to the present invention can comprise one or more solvents. The solvent component according to the invention may comprise a single solvent or a mixture of solvents. Solvents finding use in the present invention can comprise water, alcohols, ketones, esters, glycol ethers, toluene and mixtures thereof. Suitable examples of alcohols include those containing 1-10 carbons including, but not limited to, methanol, ethanol, propanol, isopropanol, n-butanol, n-pentanol and mixtures thereof. Suitable ketones include, but are not limited to, acetone, methyl ethyl ketone, methyl propyl ketone, methyl isobutyl ketone and mixtures thereof. Suitable esters include, but are not limited to, n-ethyl acetate, n-propyl acetate, isopropyl acetate, n-butyl acetate, isobutyl acetate and mixtures thereof. Suitable glycol ethers include, but are not limited to, glycol ethers including methyl, ethyl and propyl ethers of ethylene glycol as well as glycol ethers of propylene glycol including methyl, ethyl and propyl ethers. Preferred solvents and solvent mixtures for use in the present invention are those which possess a polarity selected such that when the solvent component is combined with the templating agent, or the polymeric binder composition and the templating agent, a solution that appears “optically clear”, that is clear to the human eye is provided. An optically clear material typically has a luminous transmittance of at least about 90 percent, a haze of less than about 2 percent, and an opacity of less than about 1 percent in the 400 to 700 nm wavelength range. Solvents and solvent mixtures having a Hansen solubility parameter as described below are preferred. Additionally, the solvent or solvent mixture must have sufficient volatility, usually expressed as evaporation rate, within the spray application to enable the templating agent to function to produce the droplet-shaped morphology.

Within the art, solvent evaporation rate is commonly reported relative to n-butyl acetate which is given a value of 1.0. Particularly preferred solvents for use in the invention are those with an evaporation rate of greater than 0.20, preferably at least or greater than 0.2, 0.3, 0.4, or 0.5. More preferably, greater than 0.50, preferably at least or greater than 0.50, 0.60, 0.70, or 0.75. Most preferably, greater than 0.75, preferably at least or greater than 0.75, 0.8, 0.9, 1.0, 1.1, 1.2, 1.3, 1.4, or 1.5. If a mixture of solvents is used, an average evaporation rate Eₐ can be calculated according to formula(I):

Eₐ=(Eₛ₁)(W₁)+(Eₛ₂)(W₂)+(Eₛ₃)(W₃) . . . +(Eₛₙ)(Wₙ) (I)

where Eₛ₁ represents the evaporation rate of Solvent 1 in a solvent mixture and W₁ represents the weight fraction of Solvent 1 in the solvent mixture, and each solvent used in the solvent mixture having an Eₛ and W included in Formula (I) up to and including the last “nth” Solvent “n”.

Preferred solvent mixtures are those with an average evaporation rate Eₐ of greater than 0.20, preferably at least or greater than 0.2, 0.3, 0.4, or 0.5. More preferably greater than 0.50, preferably at least or greater than 0.50, 0.60, 0.70, or 0.75. Most preferably greater than 0.75, preferably at least or greater than 0.75, 0.8. 0.9, 1.0, 1.1, 1.2, 1.3, 1.4, or 1.5.

As a means to predict solubility behavior of materials in a solvent the Hansen solubility parameters have been developed. The polar solubility parameter, σP, reflects the energy from dipolar inter molecular forces between molecules. Preferred solvents and solvent mixtures have a Hansen polar solubility parameter σP of greater than 2.0 (joules/cm³)^{1/2}. As can be seen form the data herein, particularly in Table 2, preferred solvents for use in the present invention have Hansen polar solubility parameters σP of greater than 2.0 (joules/cm³)^{1/2}, many in the range of 6.0 (joules/cm³)^{1/2} to greater than 10 (joules/cm³)^{1/2}. Preferably the Hansen polar solubility parameters σP of the solvent or mixture of solvents is at least greater than 2.0, 3.0, 4.0, 5.0, 6.0, 7.0, 8.0, 9.0, 10.0, 11.0, 12.0, 13.0, 14.0, 15.0, or 16.0 (joules/cm³)^{1/2}. As discussed herein, the solvent within the invention may constitute a single solvent or a mixture of many solvents. In a preferred embodiment a mixture of solvents is used. For a given polymeric binder and templating agent combination, polarity and evaporation rate can be chosen for a mixture of solvents to affect the evaporative droplet templating agent effect. Preferably, the solvent system comprises from 20 to 99 weight percent of the coating composition prior to drying and curing and independently, in increasing order of preference at least 20, 21, 22, 23, 24, 25, 26, 27, 28, 29, 30, 31, 32, 33, 34, 35, 36, 37, 38, 39, 40, 45, 50, 55, or 60 weight percent and independently, in increasing order of preference not more than 99, 98, 97, 96, 95, 94, 93, 92, 91, 90, 89, 88, 87, 86, 85, 84, 83, 82, 81, 80, 75, 70, 65, or 62 weight percent. Once the coating compositions are dried and cured there is no to very little residual solvent in the coating.

In embodiments wherein the polymeric binder is a UV curable binder a compatible photoinitiator is used in the composition to UV cure the polymeric binder composition. For UV curable binder compositions, the photoinitiator is required to initiate free radical or cationic polymerization. Photoinitiators, when placed under the UV light source, generate free radical species or cationic species capable of initiating polymerization leading to cured coatings. Appropriately selected photoinitiators or combinations of photoinitiators in coating formulations absorb peak wavelength bands of the radiation source, such as mercury arc UV lamps, employed to initiate polymerization leading to curing at the surface as well as within the bulk of the coating. A skilled person in the art for energy curable compositions, mainly for UV light, LED and visible light curable compositions, also knows to combine suitable photoinitiators or types of photoinitiators along with co-initiators, synergists or catalysts to significantly improve curing efficiency and performance. Preferably, the photoinitiator is present in the coating composition in an amount of from 1 to 6 weight percent based on the total weight of the UV curable materials within the formulation, preferably at least 1, 1.5, 2, 2.5, or 3 and not more than 6, 5.5, 5.0, 4.5, 4, 3.5 or 3.

Traditional free radical photoinitiators useful for the present invention classified according to their chemical groups and include, but are not limited to: (1) hydroxyacetophenones, (2) alkylaminoacetophenones, (3) benzil ketals and dialkoxy acetophenones, (4) benzoin ethers, (5) phosphine oxides, (6) acyloximino esters, (7) photoacid generators, (8) photobase generators, (9) 2,2-Bis(2-chlorophenyl)-4,4,5,5-tetraphenyl-1,2-biimidazole (BCIM) and HABI, (10) benzophenones, (11) organic sulfur compounds such as thiols, (12) substituted benzophenones, (13) benzoylformate esters, (14) anthraquinones, (15) camphorquinones, (16) oxime esters, (17) anthracene proxy radicals, and mixtures thereof. Specific examples of such photoinitiators include, but are but not limited to: benzyldimethylamino-1-(4-morpholinophenyl)butanone-1; benzil dimethylketal; dimethoxyphenylacetophenone; a-hydroxybenzyl phenyl ketone; 1-hydroxy-1-methyl ethyl phenyl ketone; oligo-2-hydroxy-2-methyl-1-(4-(1-methylvinyl)phenyl)propanone; benzophenone; methylorthobenzoyl benzoate; methyl benzoyl formate; 2,2-diethoxyacetophenone; 2,2-disec. Butoxyacetophenone; p-phenylbenzophenone; 2-isopropylthioxanthone; 2-methylanthraquinone; 2-ethylanthraquinone; 2-chloroanthraquinone; benzanthraquinone; benzyl; benzoin; benzoin methyl ether; benzoin isopropyl ether; a-phenylbenzoin; thioxanthone; diethylthioxanthone; 1,5-acetonaphthalene; 1-hydroxycyclohexyl phenyl ketone; ethyl p-dimethylaminobenzoate; titanocenes; dibenzylidene ketones; 1,2-diketones; ketocoumarins; and mixtures thereof.

Typical free radical photoinitiators useful in this invention are commercially available under tradenames that include: Irgacure® 184, Irgacure® 1173, Omnirad 102, Esacure KIP 150, Esacure KIP EM, Irgacure® 2959, Omnirad 669, Irgacure® 127, Irgacure® Micro-PICS, Esacure ONE, Irgacure® 907, Quadracure MMMP-3, Irgacure® 369, Omnipol 910, Quadracure BDMD-3, Irgacure® 379, Benzildimethyl ketal (BDK), Irgacure® 651 (DMPA), Diethoxyacetophenone (DEAP), Vicure® 10, Lucirin® TPO, Lucirin® TPO-L, Irgacure® 819, BAPO, Speedcure® PDO, Irgacure® PAG (103, 203, 108, 121), Irgacure® oxe 01, Irgacure® oxe 02, Esacure 1001M, Trigonal P1, Sandoray® 1000, Phenyl tribromomethyl sulphone (BMPS), Trichloromethyl-S-triazines, O-Nitrobenzyl carbamates, Ciba PLA-1, Irgacure® 907, Darocure® 1173, Ciba PLA-2, Speedcure® MBP, Esacure TZT, Genocure® MBB, Uvecryl® P36, Omnipol BP, Genopol BP-1, Speedcure® 7005, Goldcure 2700, Trigonal 12 (PBZ) (4-Phenylbenzophenone), Goldcure 2300, Speedcure® BMS, Esacure 1001M (sulphonylketone), Irgacure® MBF and Genocure® MBF, TX-A, Irgacure® 754 and 2-Ethylanthraquinone.

One skilled in the art of energy curable formulations can substitute free radically photo polymerizable components in the examples by cationically photopolymerizable monomers or oligomers. Conventional cationic photoinitiators potentially useful for such inventions are classified according to chemical groups and include but are not limited to: (1) sulphonium salts; (2) iodonium salts; (3) ferrocenium salts; and mixtures thereof.

Typical commercial examples of cation photoinitiators useful for such inventions are available under tradenames including: Irgacure® 250, Irgacure® 270, Irgacure® PAG 290, Irgacure® GSID 26-1, QL cure 211, QL cure 212, SP 150, Sp 170, Omnicat 550, Imnicat 555, Omnicat 650, Esacure 1187, Irgacure MacroCat, Hycure 810, Uvacure® 1600, Sarcat CD 1012, Omnicat 440, Omnicat 445, Irgacure® 250, UV 9310, Rhodorsil 2047, Rhodorsil® 2076, Irgacure® 261, Omnicat 320, Omnicat 430, Omnicat 432, Speedcure® 937, Speedcure® 938, Speedcure® 976 and 992. Molecular or polymeric co-initiators, synergists and catalysts useful for the present invention are classified based on chemical groups and include, but are not limited to: (1) primary, secondary and tertiary amines; (2) amides; (3) alpha amino acids; (4) thioxanthones; (5) thiols; and mixtures thereof. Specific examples useful for the invention include but are but not limited to: 2-ethylhexyl-p-dimethylaminobenzoate; ethyl 4-(dimethylamino) benzoate; trimethylolpropane tris (3-mercaptopropionate); methyldimethanolamine; poly (ethylene glycol) bis (p-dimethyl aminobenzoate); polyethylene glycol-di (β-(4(pacetylphenyl) piperazine)) propionate; and mixtures thereof.

Commercial available examples of co-initiators, synergists and catalysts useful for this invention include but are not limited to: Genocure® EHA, Genocure® EPD, Genocure® MEDA, Speedcure® DMB, Speedcure® EDB, Omnirad IADB, Omnipol ASA and Omnipol SZ, ITX (Isopropylthioxanthone), Kayacure DETX (Diethylthioxanthone), Speedcure® CTX (Chlorothioxanthone), Kayacure RTX (Dimethylthioxanthone), Kayacure DITX (Diisopropyl-thioxanthone), Speedcure® CPTX (1-Chloro-4-propoxythioxanthone), Speedcure® 7010, Omnipol TX, Genopol TX-1.

As discussed herein the term “evaporative droplet templating agent” is a term the present inventors have coined for the component, described herein, that aids in forming the unique droplet-shaped morphology and/or coating features of the present coatings on a substrate. The term is further defined herein and in the present specification and claims the terms “evaporative droplet templating agent” and “templating agent” mean the same thing as described herein. The templating agent functions synergistically with a selected solvent and the nanoparticles to cause formation of the unique droplet-shaped morphology of the present coating.

Preferably, the templating agent C) is present in an amount of from 0.1 to 5.0 weight percent based on the coating weight after drying and curing, preferably at least 0.1, 0.2, 0.3, 0.4, 0.5, 0.6. 0.7, 0.8, 0.9, 1.0, 1.1, 1.2, 1.3, 1.4, 1.5, 1.6, 1.7, 1.8, 1.9. 2.0, 2.1, 2.2, 2.3, 2.4, or 2.5 and not more than 5.0. 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, or 2.5. More preferably from 0.2 to 2 weight percent, preferably at least 0.2, 0.3, 0.4, 0.5, 0.6. 0.7, 0.8, 0.9, 1.0, 1.1, 1.2, or 1.3 and not more than 2.0, 1.9, 1.8, 1.7, 1.6, 1.5, 1.4, or 1.3.

Suitable templating agents C) are polymeric materials, structurally different from binder A), possessing both hydrophilic and hydrophobic moieties or portions. Desirably templating agents may comprise a polymeric templating agent that is a copolymer having both polar and nonpolar portions. The polar portions may comprise polyether portions. Desirably the polyether portions may be based on polyethylene glycol ether (meth)acrylates, for example polyethylene glycol methyl ether acrylates, polyethylene glycol methyl ether di-acrylates, polyethylene glycol methyl ether methacrylates, polyethylene glycol methyl ether di-methacrylates and mixtures thereof. The polyether portions preferably have number average molecular weights of about 272 to 2000 Daltons as described further below. The templating agent may comprise from 5 to 95 weight % of polyether portions based on the total weight of the templating agent. Desirably the nonpolar portions include monomers comprising alkyl esters of acrylic acid, alkyl esters of methacrylic acid, and mixtures thereof and wherein said alkyl groups are from C₁ to C₁₆.

Suitable templating agents can be formed from similar monomers as the polymeric binder compositions as described above; however, in a given coating composition they are structurally different from the polymeric binder composition. As discussed above, and as known in the art, monomer does not mean it is only a single repeating unit. A polyether, containing multiple ether functionalities, is considered a monomer in the present specification and claims. Desirably, the templating agents preferably are block copolymers. Preferred polymers are linear or branched acrylate and/or methacrylate copolymers. Preferred copolymers are those that constitute nonpolar groups such as those provided by alkyl esters of acrylic and methacrylic acid and polar groups provided by hydrophilic monomers. Particularly preferred polar monomers include polyether-based monomers such as acrylates and (meth)acrylates containing polyether groups located between the acrylates or (meth)acrylates. Preferred polyether monomers are those based on polyethylene glycol. A wide range of molecular weights of polyethylene glycol based monomers may be used. In a preferred embodiment the molecular weight of polyethylene glycol based monomers, number average molecular weight (Mn), may range from about 272 Daltons to about 2000 Daltons, preferably at least 272, 273, 274, 275, 280, 285, 290, 295, 300, 310, 320, 330, 340, 350, 360, 370, 380, 390, 400, 425, 450, 475, 500, 525, 550, 575, 600, 625, 650, 675, 700, 725, 750, 775, 800, 825, 850, 875, 900, 925, 950, 975, 1000, or 1025 and not more than 2000, 1999, 1998, 1997, 1996, 1995, 1994, 1993, 1992, 1991, 1990, 1989, 1988, 1987, 1986, 1985, 1984, 1983, 1982, 1981, 1980, 1970, 1960, 1950, 1940, 1930, 1920, 1910, 1900, 1875, 1850, 1825, 1800, 1775, 1750, 1725, 1700, 1675, 1650, 1625, 1600, 1575, 1550, 1525, 1500, 1475, 1450, 1425, 1400, 1375, 1350, 1325, 1300, 1275, 1250, 1225, 1200, 1175, 1150, 1125, 1100, 1075, 1050, or 1025. Most preferred range for Mn is about 400 Daltons to about 1000 Daltons, preferably at least 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, or 700 and not more than 1000, 990, 980, 970, 960, 950, 940, 930, 920, 910, 900, 890, 880, 870, 860, 850, 840, 830, 820, 810, 800, 790, 780, 770, 760, 750, 740, 730, 720, 710 or 700. Polyethylene glycol based monomers may possess a single ethylenically unsaturated group such as polyethylene glycol methyl ether acrylates, polyethylene glycol methyl ether (meth)acrylates or may possess 2 ethylenically unsaturated groups such as polyethylene glycol di-acrylates, or polyethylene glycol di-(meth)acrylates. Branched polymer templating agents of the invention can be produced by inclusion of other difunctional monomers such as divinylbenzene, as well as (meth)acrylic acid di-esters of linear aliphatic diols. Representative examples include butane diol di(meth) acrylate, hexane diol di(meth) acrylate and the like. The polyether content of the templating agent can be controlled by the weight % polyether monomer used relative to total monomer. In a preferred embodiment the weight % polyether monomer based in the on total monomer weight ranges from 5%-95%, preferably at least 5, 6, 7, 8, 9, 10, 11, 12, 13, 14, 15, 16, 17, 18, 19, 20, 25, 30, 35, 40, 45, or 50 and not more than 95, 94, 93, 92, 91, 90, 89, 88, 87, 86, 85, 84, 83, 82, 81, 80, 75, 70, 65, 60, 55, or 50. More preferably 10%-40%, preferably at least 10, 11, 12, 13, 14, 15, 16, 17, 18, 19, 20, 21, 22, 23, 24, or 25 and not more than 40, 39, 38, 37, 36, 35, 34, 33, 32, 31. 30, 29, 28, 27, 26, or 25. Preferred monomers comprising non-polar groups include alkyl esters of acrylic and methacrylic acids, wherein the alkyl groups contain 1-16 carbons. In a preferred embodiment the monomer comprising non-polar groups contains an alkyl chain length of 2-8 carbons. The hydrophobic portions of the templating agent may also include polysiloxanes. Also templating agents may optionally contain other monomers, for instance inclusion of residual acrylate or methacrylate monomers can be used to make the templating agent reactive within UV-curable coating compositions. In some embodiments the templating agent can be crosslinkable with itself or any of the film forming polymeric binder compositions described herein or both. In other embodiments the templating agent is not crosslinkable with itself or with any of the film forming polymeric binders described herein. In the case where the templating agent does not crosslink, the templating agent generally remains as part of the film matrix, similar to other additives. Any number of radical polymerization processes known in the art may be utilized to achieve polymerization of the templating agent. Polymerization may be carried out neat, within solution in solvent or in water with neat or solvent-based polymerizations being particularly preferred. Other suitable examples of evaporative droplet templating agents in accordance with the present invention include copolymers that contain acrylic backbones, meaning the backbone is formed from monomers of acrylic acid, acrylic acid esters, methacrylic acid, methacrylic acid esters and mixtures thereof and have polar polyether segments branching from the backbone in the polymers. The polyether segments are highly polar and they may interact with the nanoparticles in the coating.

Suitable optional additives that can be included in the coating composition according to the present invention include: adhesion promoting agents, slip agents, cosmetic additives including dyes, the UV photoinitiator which is used when the polymeric binder is UV curable, thermosetting polymeric binders often include UV stabilization additives as are known in the art.

The formation of the coating having the unique droplet-shaped morphology on a substrate surface may desirably be accomplished such that the coating is applied in droplet form, desirably as an atomized spray. Applying the formulation to a substrate via another process, such as roll application, draw bar application, dip application, curtain coating, or spin coating does not result in formation of the droplet-shaped morphology in the coating. In a preferred embodiment, any sort of an atomizing spraying system can be utilized. It can be a forced air or airless atomization spray system. Other atomization processes can be utilized so long as they result in formation of atomized fine droplets of the coating composition. Preferably the droplet-shaped morphology of the applied coatings according to the present invention has droplet shaped features with a size of from 1 to 100 microns in diameter, preferably at least as great as 1, 2, 3, 4, 5, 10, 15, 20, 25, 30, 35, 40, 45, or 50 and no greater than 100, 99, 98, 97, 96, 95, 90, 85, 80, 75, 70, 65, 60, 55, or 50 microns. More preferably the droplet-shaped morphology shows droplets having a size of from 5 to 50 microns in diameter, preferably at least as great as 5, 6, 7, 8, 9, 10, 15, 20, or 25 and not greater than 50, 49, 48, 47, 46, 45, 40, 35, 30, or 25 microns. The droplet-shaped morphology of the applied coating is very easily seen in the SEM figures of the coatings according to the present invention as noted herein. In the examples presented in the present specification the coatings were applied using a Binks Trophy series high volume low pressure (HVLP) gun equipped with a 1.2 millimeter nozzle using 40 psi of line pressure. The dried coating thickness can be varied over a wide range from 2 to 10 microns and beyond, preferably at least 2, 3, 4, 5, 6, 7, 8, 9, 10, 11, 12, 13, 14, 15, 16, 17, 18, 19, or 20 microns. The coated substrates are then heated and the polymeric binder is cured as appropriate for the binder, meaning thermal cure, UV cure, moisture cure and the like. A broad spectrum of electromagnetic radiation such as visible light of wavelength between 400 to 700 nm, ultraviolet (UV) light of wavelength between 200 to 400 nm, monochromatic vacuum UV light of a specific wavelength between 100 to 200 nm, energy from accelerated electron beam in the range of 80 to 300 kV and combinations thereof can be used for polymerization and curing of monomers, oligomers and polymers containing polymerizable groups such as acrylates, methacrylates, epoxies, and thiols. The mechanism of radiation polymerization and curing can be free radical polymerization, cationic polymerization or a combination of both depending upon polymerizable groups and initiating species in the compositions. At a commercial scale UV curing is the most feasible and widely used radiation curing technique due to its specific advantages over other techniques. Visible and UV light curable compositions contain photoinitiators that respond to the spectrum of UV and visible light radiations and initiate the polymerization. Conventional lamps that find use for UV curing are mercury arc lamps such as medium pressure mercury lamps (H and H+ lamps), doped medium pressure mercury lamps (V lamp with near visible light spectrum and D lamp), low pressure mercury lamps and high pressure mercury lamps. In general a mercury lamp generates a broad spectral output with a peak intensity around certain wavelength bands. A semiconductor based UV-light emitting diode (UV-LED) is a type of UV lamp which generates a very narrow and single spectral band of a specific wavelength for UV curing which can be used in certain applications. Also known are high energy quasimonochromatic vacuum UV excimer lamps.

### Testing Methods

The fingerprints were applied to the coatings using the following procedure: the tester wiped a fingertip across his/her forehead and then pressed the fingertip onto the substrate. The fingerprint visibility was tested visually and ranked on a scale of from 0 to 4, with 0 being invisible at all angles and 4 being visible at all angles. The number of wipes to remove a visible fingerprint was tested as follows: the fingerprint was wiped with a paper cloth and the number of wiping motions required to make the fingerprint invisible was recorded. The gloss, peak specular reflectance (Rspec), reflection haze, and distinctness of image (DOI) were measured with an Elcometer 408 Gloss and DOI meter. The gloss values are reported in gloss units and the Rspec in a percentage. The DOI measurement is an indication of the distinctness of an image reflected off a surface. The transmission haze in some samples was measured using a Haze-gard-i instrument manufactured by Byk-Gardner-GmbH. The hardness of the coatings was measured according to ASTM D3363 while the adhesion was measured by ASTM D 3359-93. A final assessment was a haptic quality rating of the coated surface, meaning how or what did the coated surface feel like to a human hand. Did the coated substrate feel like the metal substrate or did it feel like a coated metal substrate. This was conducted by touching the coated substrate, in the present examples the substrates were aluminum substrates so it is expressed as yes or no, did it feel like a metal substrate or like a polymeric coating.

### Examples

The present invention will now be described in more detail by means of several examples.

A series of templating agents were prepared as follows. To a 500 ml 3-necked round bottom flask, equipped with stirrer, condenser, and nitrogen inlet, were added n-butyl acrylate, a poly(ethylene glycol) methacrylate (PEGMA) with a number average molecular weight (Mn) as noted, divinylbenzene, toluene and Di(4-tert-butylcyclohexyl) peroxydicarbonate in the quantities as specified in Table 1 below. The mixture was heated to 75° C. under agitation and a nitrogen blanket. A pre-dissolved Di(4-tert-butylcyclohexyl) peroxydicarbonate solution in toluene, 0.9 g of Di(4-tert-butylcyclohexyl) peroxydicarbonate in 20 g of toluene, was then metered into the reactor for 2 hours. After completion of the addition, the reactor was held at 75° C. for another 1 hour. Two shots of Di(4-tert-butylcyclohexyl) peroxydicarbonate solution in toluene, 0.15 g of Di(4-tert-butylcyclohexyl) peroxydicarbonate in 5 g of toluene, were added separately in the reactor 30 minutes apart. The reaction mixture was maintained until the polymerization was complete. Each polymer solution was cooled before being added into the coating compositions.

TABLE 1

| | | PEGMA | PEGMA | | | Di(4-tert- |
|---|---|---|---|---|---|---|
| Tem- | n-Butyl | Mn = | Mn = | Divinyl- | Tol- | butylcyclohexyl) |
| plating | acrylate | 500 | 950 | benzene | uene | peroxydicarbonate |
| agent | (g) | (g) | (g) | (g) | (g) | (g) |
| 1A | 35 | 15 | | 0.075 | 123 | 0.3 |
| 1B | 35 | | 15 | 0.075 | 123 | 0.3 |
| 1C | 30 | 20 | | 0.075 | 123 | 0.3 |
| 1D | 40 | 10 | | 0.1 | 123 | 0.3 |

Additional polymeric solutions that were found to act as templating agents in the present invention included templating agents designated herein as templating agents 2A and 2B. Both are commercially available polymers with 2B containing UV curable functional groups in the polymer. The polymers comprise polyacrylate backbones modified with polyether macromers. Both have an active concentration of 100%.

A solvent blend, designated Solvent 1 was prepared by combining the quantities of the solvents noted below in Table 2. Also provided are the values for the evaporation rate as described herein, the rate of n-butyl acetate being 1.0, and the Hansen polar parameter for each component.

TABLE 2

| | | | Hansen |
|---|---|---|---|
| | | | polar |
| | | Evaporation | parameter |
| Component | Grams | rate | (Joule/cm³)^{1/2} |
| Acetone | 300 | 6.3 | 10.4 |
| Isopropanol | 108 | 1.7 | 6.1 |
| Methyl isobutyl | 108 | 1.6 | 6.1 |
| ketone | | | |
| Propylene | 84 | 0.7 | 6.3 |
| glycol methyl | | | |
| ether | | | |
| TOTAL | 600 | | |

Next a series of coating compositions, Inv. 3A-3C and Inv. 5A-5E, according to the present invention and a comparative coating composition, designated throughout the specification as comp. ex. 1, were prepared by mixing, using a magnetic stir bar, the components listed below in Tables 3 and 4 were added in the order listed. The nano-silica modified trifunctional urethane acrylate and the nano-silica modified polyether acrylate both had a silica content of 50% by weight and the silica had a nominal particle size of 20 nm.

TABLE 3

| Component | Comp. | Inv. | Inv. | Inv. |
|---|---|---|---|---|
| (grams) | ex. 1 | 3A | 3B | 3C |
| Nano-silica modified | 120.0 | 120.0 | 60.0 | |
| trifunctional urethane acrylate | | | | |
| Nano-silica modified | | | | 60.0 |
| polyether acrylate | | | | |
| Aliphatic polyester | | | 12.9 | 12.1 |
| urethane diacrylate | | | | |
| Urethane acrylate in | | | 11.8 | |
| 30% hexanediol | | | | |
| diacrylate (HDDA) | | | | |
| polyester-modified | | | | 11.1 |
| acrylate oligomer | | | | |
| High Tg monofunctional | | | 10.7 | 10.1 |
| monomer | | | | |
| Tricyclodecane | | | 10.7 | 10.1 |
| dimethanol diacrylate | | | | |
| Dipentaerythritol | | | 7.5 | 7.1 |
| penta acrylate | | | | |
| Trifunctional acid ester | | | 5.4 | 5.0 |
| 2-Hydroxy-2-methyl-1- | 3.0 | 3.0 | 4.5 | 5.1 |
| phenyl-propan-1-one | | | | |
| (photoinitiator) | | | | |
| Solvent 1 | 78.0 | 78.0 | 67.6 | 59.2 |
| templating agent 2B | 0.0 | 1.3 | 1.3 | 1.2 |

TABLE 4

| Component ) | Inv. | Inv. | Inv. | Inv. | Inv. |
|---|---|---|---|---|---|
| (grams | 5A | 5B | 5C | 5D | 5E |
| Nano-silica modified | 120.0 | 120.0 | 120.0 | 120.0 | 120.0 |
| trifunctional | | | | | |
| urethane acrylate | | | | | |
| 2-Hydroxy-2-methyl-1- | 3.0 | 3.0 | 3.0 | 3.0 | 3.0 |
| phenyl-propan-1-one | | | | | |
| (photoinitiator) | | | | | |
| Solvent 1 | 76.1 | 75.8 | 76.0 | 76.0 | 78.0 |
| Templating agent | 2.5 | 2.9 | 2.6 | 2.6 | 0.7 |
| | 1A | 1B | 1C | 1D | 2A |

Each coating composition was applied by air atomized spraying to clean aluminium panels using a Binks Trophy series HVLP gun equipped with a 1.2 mm nozzle and 40 psi. line pressure to achieve 10 microns applied coating thickness, unless otherwise noted, after drying and curing. Two types of treated aluminium panels were utilized as noted. In some experiments the aluminium panels were aluminum 6061 panels that were cleaned by immersion in a heated aqueous alkaline cleaner at 52° C. for a period of 5 minutes followed by water rinsing, then etched according to ASTM D2651 followed by water rinsing then anodized according to ASTM D3933. Treated panels were rinsed with water then dried prior to application of the coating compositions. These panels were designated as anodized aluminium panels. Other panels were aluminium 6061 planes that were cleaned by immersion in Bonderite C-AK 6849 Aero Alkaline cleaner made up at a 20% concentration and maintained at 140° F. Immersion time was 210 seconds after which panels were rinsed for 60 seconds, followed by immersion in Bonderite M-NT 5200 chrome free conversion coating, 3 wt % active concentration, for 60 seconds followed by a 60 second warm water rinse and forced air drying. These panels were designated as Bonderite 5200 aluminum panels. After spray application of the coating compositions the panels were heated in an electric oven for a period of 10 minutes at a temperature of 71° C. to dry off the solvent, after which they were cured via a UV oven equipped with an H+UV bulb with an exposure of 1700 mJ/cm² UVC thus forming the coatings.

The cured coatings were subjected to scanning electron microscopy (SEM) using a Hitachi 3500 SEM/EDX. In some samples the SEM was performed at 15 keV in high vacuum mode using back scatter electron detection in others it was performed at 15 keV in low vacuum mode using secondary electron detection. Results are shown in the various figures described herein. The cured coatings were also subjected to a series of evaluations as described herein for: fingerprint visibility, number of wipes to remove fingerprints, gloss, Rspec, DOI, reflection haze, hardness, X-hatch adhesion, and metal feel. The results are presented below in Tables 5A, 5B and 6. The data in Table 5A was generated from a substrate of anodized aluminum while the data in Tables 5B and 6 were generated on Bonderite 5200 aluminum panels.

TABLE 5A

| | Comp. | Inv. | Inv. | Inv. |
|---|---|---|---|---|
| | ex. 1 | 3A | 3B | 3C |
| | anodized | anodized | anodized | anodized |
| Test | aluminum | aluminum | aluminum | aluminum |
| Fingerprint | 4 | 0 | 0 | 0 |
| Visibility | | | | |
| # Wipes to Remove | 6 | 0 | 0 | 0 |
| Gloss (gloss units) | 160 | 7 | 7 | 28 |
| Rspec | 91% | 1% | 1% | 2% |
| pencil hardness | 9 H | 9 H | 9 H | 9 H |
| X-hatch adhesion | 100% | 100% | 100% | 100% |
| Metal Feel | No | Yes | Yes | Yes |

TABLE 5B

| | Comp. ex. 1 | Inv. 3A |
|---|---|---|
| | Bonderite | Bonderite |
| Test | 5200 Al | 5200 Al |
| Fingerprint visibility | 4 | 0 |
| Number of wipes to remove | 6 | NA |
| Gloss (gloss units) | 99 | 10 |
| Distinctness of image (DOI) | 49 | 28 |
| Reflection haze | 92% | 24% |
| Rspec | 91% | 2% |
| Pencil hardness | 9 H | 9 H |
| X-hatch adhesion | 100% | 100% |
| Metal feel | No | Yes |

TABLE 6

| | Inv. | Inv. | Inv. | Inv. | Inv. |
|---|---|---|---|---|---|
| Test | 5A | 5B | 5C | 5D | 5E |
| Fingerprint Visibility | 0 | 1 | 2 | 1 | 1 |
| # Wipes to Remove | 0 | 2 | 2 | 2 | 3 |
| Gloss (gloss units) | 35.0 | 22.0 | 27.0 | 59.0 | 18.0 |
| Rspec | 2.6% | 1.5% | 2.2% | 4.4% | 1.4% |
| pencil hardness | 9 H | 9 H | 9 H | 9 H | 9 H |
| X-hatch adhesion | 100% | 100% | 100% | 100% | 100% |
| Metal Feel | Yes | Yes | Yes | Yes | Yes |

The results show the significant ability of the coatings according to the present invention to hide fingerprints on a substrate. The fingerprints were invisible on the substrates coated according to the present invention, with examples Inv. 3A-C and Inv. 5A being extremely effective. The fingerprints were very obvious on the substrate that had not been coated according to the present invention. As shown by the values for the gloss and peak specular reflectance the coatings according to the present invention are much less reflective and have less gloss than the comparative coating and this reduced reflectance and gloss serve to hide the fingerprints on the coatings. Preferably the peak specular reflectance is 5% or less, preferably less than 4.5%, 4.0%, 3.5%, 3.0%, 2.5%, or 2%. The test results also showed that the coating according to the present invention maintained the hardness and scratch resistance despite the droplet-shaped morphology of the coatings according to the present invention. In addition, all of the coatings according to the present invention provided a haptic result that they feel like the metal substrate rather than like a coated metal. As shown in the results reported in Table 5B the invention coating also greatly reduced the distinctness of image and reflection haze.

A series of the coating compositions coated onto either the Bonderite 5200 treated aluminum or anodized aluminum panels were subjected to scanning electron microscopy (SEM) using a Hitachi 3500 SEM/EDX. In some samples the SEM was performed at 15 keV in high vacuum mode using back scatter electron detection in others it was performed at 15 keV in low vacuum mode using secondary electron detection with a deeper scanning depth.

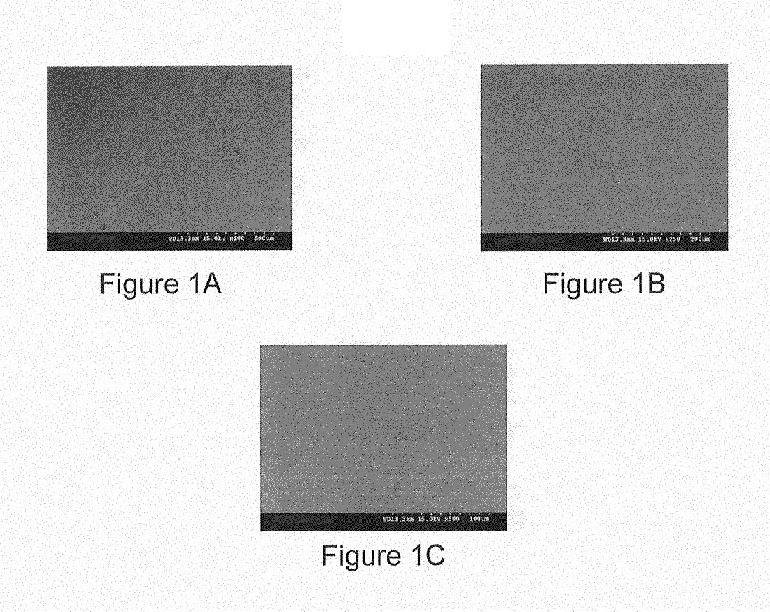

FIGS. 1A, 1B and/C show comparative coating Comp. Ex. 1, not according to the present invention, coated at 10 microns dried coating thickness on Bonderite 5200 aluminum panels. FIG. 1A is at a magnification of 100×, FIG. 1B is at 250×, and FIG. 1C is at 500×. The SEM was performed at 15 keV in high vacuum mode using back scatter electron detection. The coating shows a uniform coalesced texture across the entire field of view with no distinguishing features.

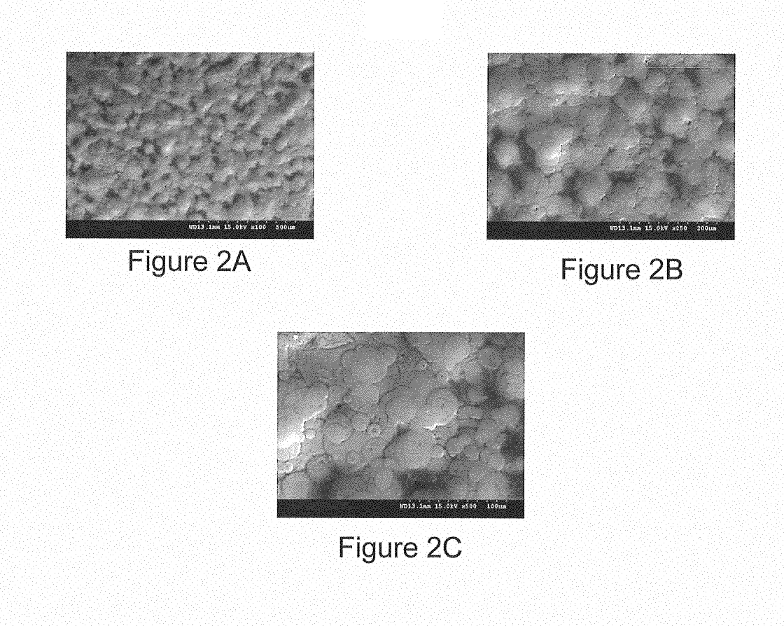

FIGS. 2A, 2B and 2C show inventive Coating Inv. 3A, according to the present invention, coated at 10 microns dried coating thickness on Bonderite 5200 aluminum panels. FIG. 2A is at a magnification of 100×, FIG. 2B is at 250×, and FIG. 2C is at 500×. The SEM was performed at 15 keV in high vacuum mode using back scatter electron detection. By way of contrast to the images shown in FIGS. 1A, 1B and 1C, these show the unique droplet-shaped morphology of the coating according to the present invention. The entire coating shows the droplet-shaped morphology over the whole field of view. The droplet-shaped morphology results because the droplets do not coalesce after they are projected onto the substrate as fine droplets. They retain their approximate droplet shape and size. The droplet-shaped morphology creates a surface having very diffuse reflection and increased inner reflections with in the droplets. This is seen as a reduction of the gloss, Rspec, DOI and reflection haze of the surfaces. Preferably the droplet-shaped morphology of the applied coatings according to the present invention has droplet shaped features with a size of from 1 to 100 microns in diameter, preferably at least as great as 1, 2, 3, 4, 5, 10, 15, 20, 25, 30, 35, 40, 45, or 50 and no greater than 100, 99, 98, 97, 96, 95, 90, 85, 80, 75, 70, 65, 60, 55, or 50 microns. More preferably the droplet-shaped morphology shows droplets having a size of from 5 to 50 microns in diameter, preferably at least as great as 5, 6, 7, 8, 9, 10, 15, 20, or 25 and not greater than 50, 49, 48, 47, 46, 45, 40, 35, 30, or 25 microns. The droplet-shaped morphology is very easily seen in the SEM figures of the coatings according to the present invention as noted herein.

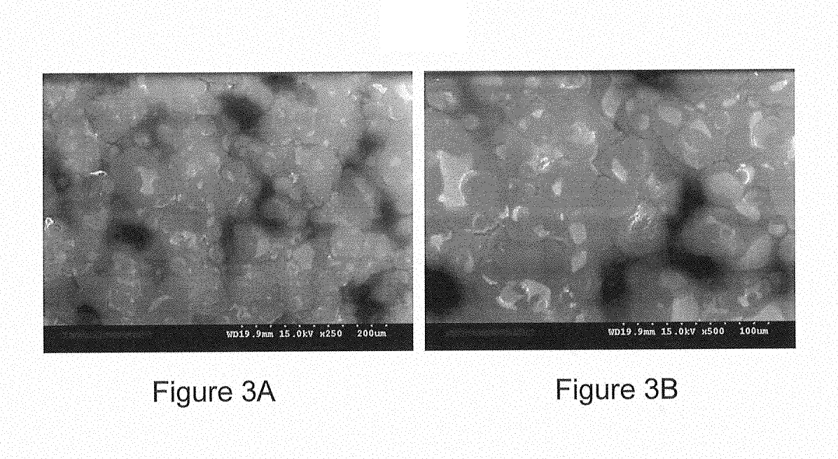

FIGS. 3A and 3B are SEMs from the same samples as FIGS. 2A-2C; however the SEM was performed at 15 keV in low vacuum mode using secondary electron detection with a deeper scanning depth. This method reveals the three dimensional structure of the droplet-shaped morphology. FIG. 3A is at a magnification of 250× while FIG. 3B is at a magnification of 500×. The droplet-shaped morphology is clearly visible and very unique and distinctive. It is believed that this droplet-shaped morphology is what contributes to the ability to hide fingerprints and to serve as an antiglare coating. The droplet-shaped morphology structure is believed to interact with incident light to cause a lot of scattering and this contributes to the very low values for gloss, DOI, Rspec, and reflection haze, which in turn helps to hide fingerprints.

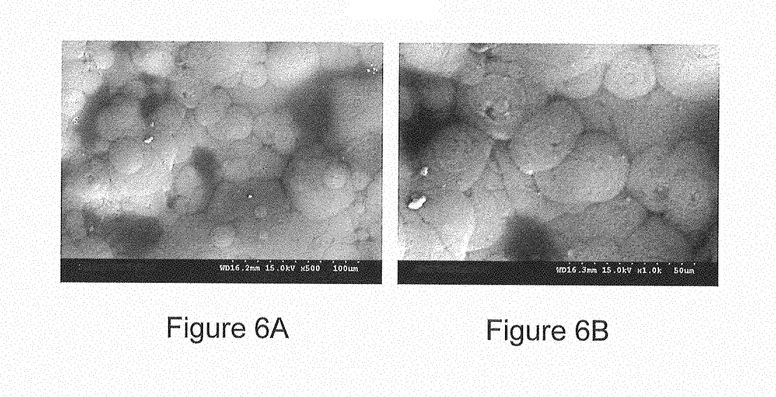

FIGS. 6A and 6B show invention Coating Inv. 5E coated onto Bonderite 5200 treated aluminum at 10 microns thickness dried coating. FIG. 6A is at a magnification of 500× and FIG. 6B is at 1000×. The SEM was performed at 15 keV in high vacuum mode using back scatter electron detection. The SEM images clearly show the unique droplet-shaped morphology of the invention which is in keeping with the ability of this coating to hide fingerprints and to show the low gloss and Rspec.

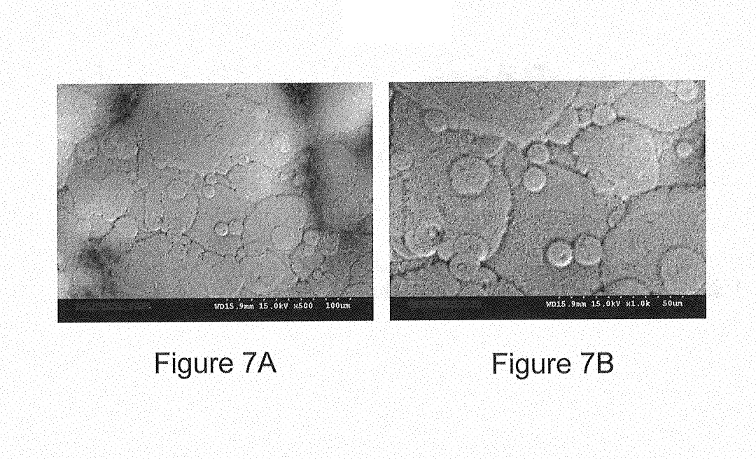

FIGS. 7A and 7B show invention Coating Inv. 5A coated onto Bonderite 5200 treated aluminum at 10 microns thickness dried coating. FIG. 7A is at a magnification of 500× and FIG. 7B is at 1000×. The SEM was performed at 15 keV in high vacuum mode using back scatter electron detection. The SEM images clearly show the unique droplet-shaped morphology of the invention which is in keeping with the ability of this coating to hide fingerprints and to show the low gloss and Rspec.

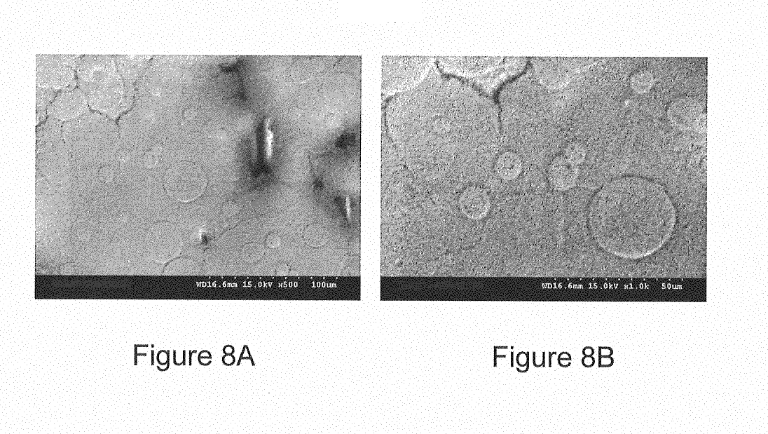

FIGS. 8A and 8B show invention Coating Inv. 5B coated onto Bonderite 5200 treated aluminum at 10 microns thickness dried coating. FIG. 8A is at a magnification of 500× and FIG. 8B is at 1000×. The SEM was performed at 15 keV in high vacuum mode using back scatter electron detection. The SEM images clearly show the unique droplet-shaped morphology of the invention which is in keeping with the ability of this coating to hide fingerprints and to show the low gloss and Rspec.

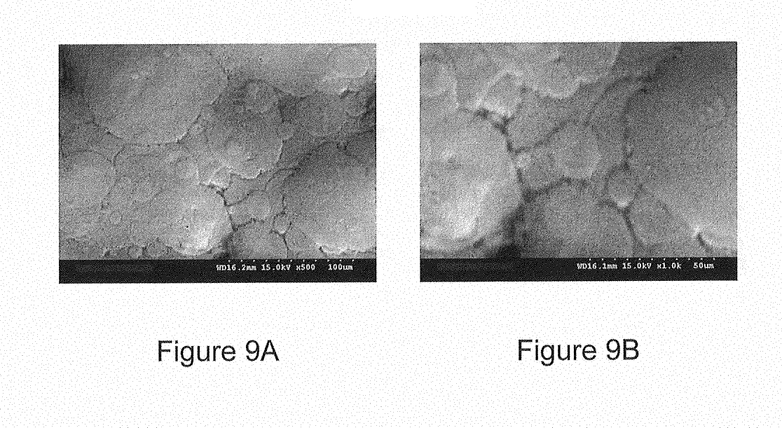

FIGS. 9A and 9B show invention Coating Inv. 5C coated onto Bonderite 5200 treated aluminum at 10 microns thickness dried coating. FIG. 9A is at a magnification of 500× and FIG. 9B is at 1000×. The SEM was performed at 15 keV in high vacuum mode using back scatter electron detection. The SEM images clearly show the unique droplet-shaped morphology of the invention which is in keeping with the ability of this coating to hide fingerprints and to show the low gloss and Rspec.

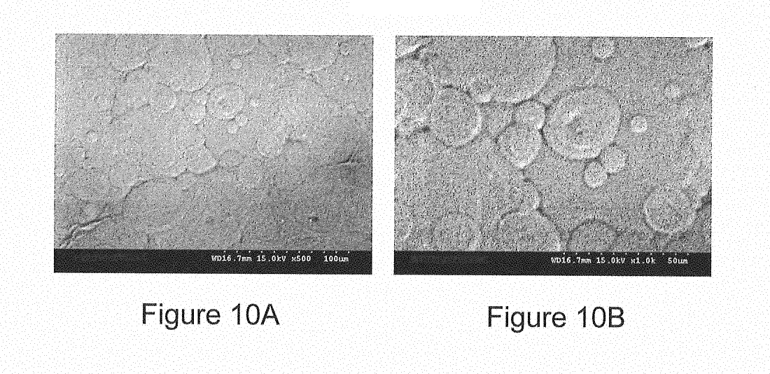

FIGS. 10A and 10B show invention Coating Inv. 5D coated onto Bonderite 5200 treated aluminum at 10 microns thickness dried coating. FIG. 10A is at a magnification of 500× and FIG. 10B is at 1000×. The SEM was performed at 15 keV in high vacuum mode using back scatter electron detection. The SEM images clearly show the unique droplet-shaped morphology of the invention which is in keeping with the ability of this coating to hide fingerprints and to show the low gloss and Rspec.

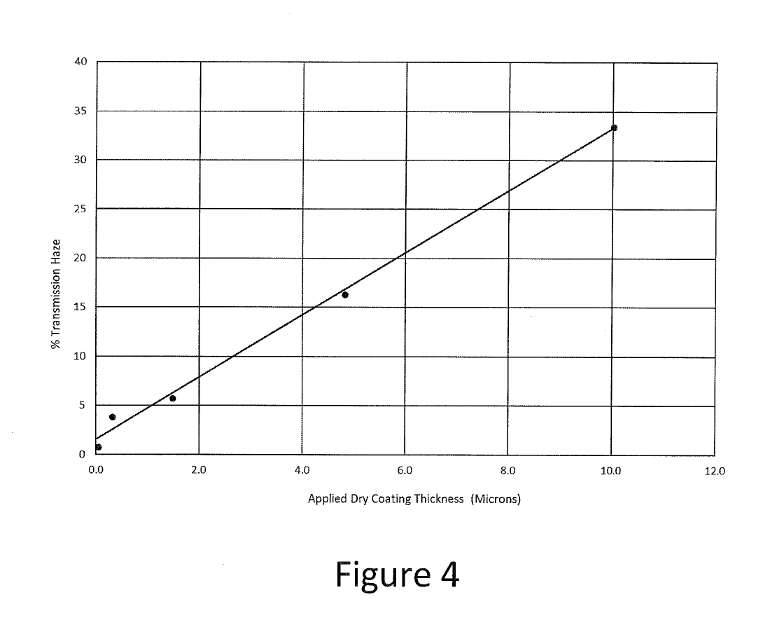

FIG. 4 shows a graph of transmission haze as a function of coating thickness for invention Coating Inv. 3C applied to a glass substrate at a variety of thicknesses. At each thickness the % transmission haze was recorded as described herein. The figure shows that the increase in % transmission haze is linear and directly proportion to coating thickness. This suggests that the morphology is the same at each thickness, in other words the droplet-shaped morphology is not coating thickness dependent. This data also shows that the present invention can be utilized as an anti-glare coating.

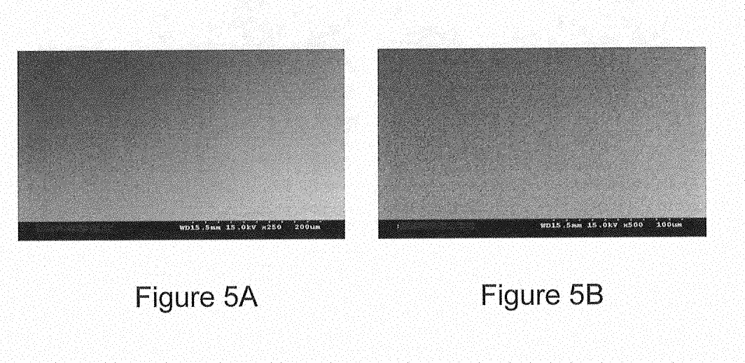

In a further example the coating composition according to the present invention, designated as Inv. 3A above in Tables 3, 5A, and 5B was applied to anodized aluminum panels by a drawbar application method rather than a spray application. The coating thickness was 10 microns as for the spray applied samples and the drying and curing steps were the same. The coated samples were then tested as described herein for various parameters and examined by SEM as described herein. The testing results are shown below in Table 7. The SEM was performed at 15 keV in high vacuum mode using back scatter electron detection and the results are shown in FIGS. 5A and 5B. In the absence of spray atomization, evaporation of the solvents within the coating composition occurs primarily after film formation. Under these conditions there was no formation of droplet-shaped morphology and the fingerprint hiding ability was lost. As shown in FIGS. 5A and 5B, at 250× and 500× magnification respectively, there was no droplet-shaped morphology in the image. Instead it looks like the comparative control images in FIGS. 1A, 1B and 1C wherein the coating composition was fully and uniformly distributed across the substrate and coalesced, and one does not see any droplet-shaped morphology. Likewise the data shown in Table 7 shows a loss of the fingerprint hiding characteristics. The gloss was very high, much closer to the comparative examples without templating agent, and the peak specular reflectance (Rspec) was likewise very high. The fingerprints are highly visible and there was no metal haptic quality to the coating. This data shows the importance of the spray application for success of the present invention.

TABLE 7

| | Coating Inv. 3A |
|---|---|
| Test | applied by drawbar |
| Fingerprint Visibility | 3 |
| # Wipes to Remove | 4 |
| Gloss (gloss units) | 97.6 |
| Rspec | 89.0% |
| Metal Feel | No |

In the next series of experiments the importance of the solvent for achieving the result was investigated by preparing a coating composition similar to Inv. 3A, except rather than using Solvent 1 the solvent used was 100% ethylene glycol butyl ether. The formulation was as presented below in Table 8. The coating composition was spray applied to anodized aluminum panels, dried and cured as described herein. For comparison to Solvent 1, the 100% ethylene glycol butyl ether solvent has an evaporation rate of only 0.09, well below the desired level of 0.2. It has a Hansen polar solubility parameter σP of 5.1 (joules/cm³)^{1/2}. The panels were then examined for the fingerprint hiding parameters as shown in Table 9 below and by SEM as described herein.

TABLE 8

| Component | g |
|---|---|
| Nano-silica modified | 120.0 |
| trifunctional urethane | |
| acrylate (50% silica content) | |
| 2-Hydroxy-2-methyl-1phenyl- | 3.0 |
| propan-1-one (photoinitiator) | |
| Solvent ethylene | 78.0 |
| glycol butyl ether | |
| templating agent 2B | 1.3 |

TABLE 9

| Test | Value |
|---|---|
| Fingerprint Visibility | 3 |
| # Wipes to Remove | 1 |
| Gloss | 112% |
| Rspec | 54.6% |
| Metal Feel | No |

The results of Table 9 show that with the new solvent of 100% ethylene glycol butyl ether the fingerprint hiding characteristics were compromised. The fingerprint visibility went up very high as did the gloss and peak specural reflectance values. The haptic sensation was also lost from the coating. Although not shown the SEM analysis likewise showed a complete loss of the droplet-shaped morphology. There were no nano structures in the SEM, instead the coating was uniform. One explanation for this behavior is that a 100% solvent of ethylene glycol butyl ether has a very low evaporation rate of only 0.09 and this is too low to allow for evaporation of some of the solvent during spray delivery such that the strong interactions of the templating agent within the evaporative droplet templating method are not triggered. This delayed evaporation may allow for the coating composition to coalesce despite the presence of the templating agent.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A coating composition comprising:
A) a film forming polymeric binder composition;
B) a plurality of nanoparticles;
C) a polymeric templating agent, different from A); and
D) at least one solvent.

2. The coating composition as recited in claim 1 wherein said polymeric templating agent is a copolymer having both polar and nonpolar portions.

3. The coating composition as recited in claim 2 wherein said nonpolar portions include monomers comprising alkyl esters of acrylic acid, alkyl esters of methacrylic acid, and mixtures thereof and wherein said alkyl groups are from C₁ to C₁₆.

4. The coating composition as recited in claim 2 wherein said polar portions comprise polyether portions, and optionally said polyether portions have number average molecular weights of from 272 to 2000 Daltons.

5. The coating composition as recited in claim 4 wherein said polyether portions comprise polyethylene glycol methyl ether acrylates, polyethylene glycol methyl ether di-acrylates, polyethylene glycol methyl ether methacrylates, polyethylene glycol methyl ether di-methacrylates and mixtures thereof.

6. The coating composition as recited in claim 4 wherein said polymeric templating agent comprises from 5 to 95 weight % of polyether portions based on total weigh of the polymeric templating agent.

7. The coating composition as recited in claim 2 wherein said polymeric templating agent comprises one or more of divinylbenzene, at least one methacrylic di-ester of a linear aliphatic diol, and mixtures thereof.

8. The coating composition as recited in claim 1 wherein said polymeric templating agent comprises a mixture of an alkyl ester of acrylic acid, divinylbenzene, and a polyethylene glycol methacrylate.

9. The coating composition as recited in claim 1 wherein said polymeric templating agent is present in an amount of from 0.1 to 5 weight % based on the total combined weight of components A), B) and C).

10. The coating composition as recited in claim 1 wherein said at least one solvent comprises at least one of water, a C₁ to C₁₀ alcohol, a ketone, an ester, a glycol ether, toluene, or a mixture thereof and wherein said at least one solvent has an average evaporation rate of 0.20 or greater.

11. The coating composition as recited in claim 1 wherein said solvent is present in an amount of from 20 to 99 weight % based on the total combined weight of components A), B), C) and D).

12. The coating composition as recited in claim 1 wherein said plurality of nanoparticles have an average diameter of from 5 to 120 nanometers.

13. The coating composition as recited in claim 1 wherein said nanoparticles comprise at least one of silica, titania, alumina, zirconia, cerium and mixtures thereof.

14. The coating composition as recited in claim 1 wherein said nanoparticles are present in an amount of from 5 to 60 weight % based on the total combined weight of components A), B), and C).

15. The coating composition as recited in claim 1 wherein said film forming polymeric binder comprises one or more of a (meth)acrylic polymer, a polyurethane polymer, a polyester polymer, a polyvinyl butyral polymer, and mixtures thereof.

16. The coating composition as recited in claim 1 wherein said film forming polymeric binder comprises from 39.9 to 94.9 weight % of the combined weight of components A), B), and C).

17. The coating composition as recited in claim 1 wherein said film forming polymeric binder composition comprises at least one of an ultraviolet curable polymer, a thermosetting polymer, and mixtures thereof and wherein said coating composition further includes at least one photoinitiator when at least one ultraviolet curable polymer is included.

18. The coating composition as recited in claim 1 wherein said coating composition further comprises at least one of an adhesion promoting agent, a slip agent, a cosmetic additive, a photoinitiator, a UV stabilizer, an auxiliary crosslinking agent, and mixtures thereof.

19. A method of forming a coating on a substrate comprising the steps of:
a) providing the coating composition according to claim 1;
b) applying the coating composition in droplet form to a substrate thereby creating an uncured coating having a droplet-shaped morphology, which is retained in the uncured coating, said coating composition applied in a sufficient amount to provide a dried cured coating thickness of 1 micron or greater; and
c) curing the uncured coating having the droplet-shaped morphology on the substrate thereby forming a coating having a droplet-shaped morphology on the substrate.

20. The method as recited in claim 19 wherein step b) comprises applying the coating composition in an amount such that the dried cured coating thickness is 2 microns or greater.

21. The method as recited in claim 19 wherein step b) comprises spray applying the coating composition to form non-coalesced droplets on the substrate creating the droplet-shaped morphology; wherein said substrate surface is not texturized prior to deposition of said coating.

22. The method as recited in claim 19 wherein step c) comprises drying the coating composition to evaporate the solvent and then curing the film forming polymeric binder composition thereby forming a fingerprint hiding coating having the droplet-shaped morphology on the substrate.

23. An article of manufacture made according to the method of claim 19.

24. An article of manufacture comprising a substrate surface, and adhered to the substrate surface a coating comprising the coating composition according to claim 1, deposited in droplets on the substrate surface and cured; and wherein said coating has a droplet-shaped morphology on said substrate surface.

25. An article of manufacture as recited in claim 24 wherein said substrate surface comprises one of a metal, a transparent plastic, a non-transparent plastic, a glass, a peelable backing material, a film, a ceramic material, a composite material, and combinations thereof and said substrate surface is not texturized prior to deposition of said coating.

26. An article of manufacture as recited in claim 24 wherein said coating on said substrate surface has a peak specular reflectance of 5% or less.

27. An article of manufacture comprising a substrate surface and adhered thereon a polymeric coating comprising droplet-shaped cured polymer, and a plurality of nanoparticles dispersed in the droplet-shaped cured polymer.
